(19) United States
(12) Patent Application Publication
(10) Pub. No.: US 2006/0118313 A1
(43) Pub. Date: Jun. 8, 2006

(54) Surface-contouring implement

(76) Inventor: James A. Nicholas, Hubbard, OR (US)

Correspondence Address: PETER A. HAAS, ESQUIRE, 1929 SW 13TH AVENUE, PORTLAND, OR, 97201, US

(21) Appl. No.: 11/006,836

(22) Filed: Dec. 8, 2004

(51) Int. Cl. A01B 31/00

(52) U.S. Cl. 172/684.5

(57) ABSTRACT

The present invention relates to a grading device adapted for easy and quick connection to a pulling machine, such as a tractor or dozer, utilizing two points of attachment provided by the pulling machine. The grading device has two main blades, each with an extendable blade to increase the contouring range. Each main blade is separated by an intermediate pivoting member, which enables independent movement of each blade. Accordingly, the device can crown or v-notch a loose surface in a single pass. Additionally, a remotely located joystick assembly enables control of the blades from an ergonomic position on the pulling machine.

### BACKGROUND

A. Field of the Invention

This invention relates to machines that move or push loose material such as, loose dirt, soil, gravel, asphalt, and the like. More particularly, this invention relates to grading devices adapted for mounting to a tractor for use in surface contouring and similar operations.

B. Description of Related Art

Grading surfaces with tractor-mounted devices are generally accepted because the relatively lighter-weight tractor is well suited to contouring, leveling, and smoothing surface soil, gravel, and dirt. Heavier-weight machines often are not acceptable for grading operations because they are not sufficiently maneuverable, their weight damages the surface, and they are expensive to operate.

Traditional approaches for grading, contouring, or otherwise shaping surfaces utilize tow-behind devices, such as grading boxes or blades. The traditional approach relies heavily on operator skill. For example, to grade a particular surface in a desired contour, such as “crowning” for a road, the operator must make real-time adjustments to the relative position of the grading device relative to the pulling device due to surface irregularities inherent to the targeted grading surface. This requires skill and constant attention to the grading device as it traverses the target surface. Certain prior-art devices demand attention and skill to operate because—left unattended—the devices will amplify irregularities, which is contrary to the desired outcome of a smooth or precisely contoured surface. For example, some prior-art devices extend from the rear of a pulling machine (for example, a tractor) and “float” or drag on the ground. Examples of devices that float on ground include the devices of U.S. Pat. No. 4,124,080 to McCanse entitled “Tractor Mounted Scraper Blade” (the McCanse reference), U.S. Pat. No. 4,579,178 to Dover entitled “A Grader Attachment for Tractors” (the Dover reference), U.S. Pat. No. 5,397,200 to Seal entitled “Spreader/Grader with Adjustable Transverse Blades” (the Seal reference), U.S. Pat. No. 5,407,013 to Scott entitled “Gravel Scarifying and Leveling Device (the Scott reference), and U.S. Pat. No. 6,322,287 to Yelton entitled “Aggregate Grading Machine” (the Yelton reference). Each of these aforementioned devices require down force supplied by the weight of the implement and the hitch-mechanism on the tractor to contour the surface. A common hitch-mechanism is a three-point hitch and the traditional approach requires the hitch be in a “locked” position, which improves the transfer of down force to the float-device. This approach, however, is disadvantageous because the inevitable surface irregularities cause the float-device to bounce. This bounce is characterized by both the tendency of the device to lift off the surface and to burrow beneath the desired level of the surface in response to the pulling machine's relative motion over a ridge or into a trough. To counter the undesirable effects of bounce, a skilled operator will make real-time adjustments and alter the down force by either lowering or lifting the float-device relative to the tractor.

One attempt to counter the lift-tendency of float-type-devices is to add a set of caster-wheels to the drag-behind device. For example, U.S. Pat. No. 4,299,220 to Nunes entitled “Grading Machine and Blade Moving Structure Therefore” (the Nunes reference) discloses a device with trailing caster-wheels. Additionally, the Nunes device incorporates a sophisticated laser sensor and receiver apparatus carried by the grading machine for raising and lowering the grading blade as the receiver falls and rises while traveling across a field. This approach requires a laser generator to be positioned off the grader device and arranged to have a clear-view of the corresponding receiver on the grader device. In addition, the sensor must precisely position relative to the blade so the device can adjust the blade up or down in time to compensate for the sensed surface irregularity. This approach is disadvantageous because it requires precise alignment of the laser generator, sensor, and receiver. Also, this approach adds complexity and sophistication that may be cost-prohibitive in many applications.

It is well known that an increase in the effective length of a drag-behind grading implement will improve the performance. For example, U.S. Pat. No. 4,364,438 to Pyle entitled “Dual Tractor Road Grader with Double Arched Center Frame” (the Pyle reference) displays such a structure. However, for many grading operations, the device of the Pyle reference is overly large, difficult to maneuver, costly to operate, and not suited to smaller grading operations.

Another limitation of prior-art devices is the ability to provide a “crowned” or its opposite, the “v-shaped” contour, in a single pass. Many prior-art devices include a movable blade. In some examples the blade is restricted to move vertically up or down relative to the grading surface: for example, the aforementioned Scott reference provides for depth control of the scarifier/grader attachment, the aforementioned Yelton reference provides a tilting mechanism for manipulating the blade in the vertical plane, and U.S. Pat. No. 6,739,404 to Keigley entitled “Wheel Supported Implement for Working and Grading Soil” (the Keigley reference) discloses a scarifying blade that tilts in the vertical plane to alter the penetration depth of the scarifying teeth. Other prior-art devices add rotation of the blade relative to the horizontal plane: for example, the aforementioned McCanse reference discloses a blade that pivots right or left relative to the pulling tractor. Yet other prior-art devices include rotation about an axis vertical to the plane: for example U.S. Pat. No. 6,672,401 to Crowley entitled “Towable Box Grader with Electronically Controlled Continuously Variable Multi-axis Blade System (the Crowley reference) discloses a single, rigid blade that can pivot in the vertical plane. Despite the versatility exhibited be each of the aforementioned references, they are unable to provide a v-shaped notch or a crown in a single pass.

Blade extensions, mechanisms that increase the surface area of a rigid blade, are employed to more efficiently grade a surface. For example, U.S. Pat. No. 6,523,620 to Burson entitled “Movable Blade for Material Moving Machines” (the Burson reference) utilizes rotatable, rectangular-shaped, and movable blades that hinge from the edge of a rigid blade assembly. This approach is directed to filling ditches, for example. Limitations of the Burson reference include the complex hinge-structure and an overly limited range of the extension blade as applied to grading large surface areas.

Traditional devices for grading or contouring a surface typically include multiple control levers arranged on the pulling tractor. The control levers facilitate manipulation of the blade. Accordingly, one control lever may raise and lower the blade, a second control lever may rotate the blade around a horizontal axis. A third control lever may alter the pitch of the blade, etc. Typically, multiple control lines, such as hydraulic feed and return lines extended from the control lever on the tractor to a corresponding apparatus, such as a hydraulic cylinder, on the grading device. This approach is somewhat disadvantageous because it requires numerous individual control lines between the tractor and the grading device, each of which is subject to wear, fatigue, and failure. Moreover, the multiple control lines must be engaged each time the grading device was attached to the tractor and disengaged each time the grading device was removed from the tractor. The constant engaging and disengaging of multiple lines is inefficient, introduces a potential error of connecting the wrong line to a particular control lever, and increases the likelihood of early fatigue, wear, or failure in the feed line. In addition, the control levers placed on the tractor are often difficult-to-reach locations, making operation cumbersome and hazardous.

The prior-art devices are not well-suited to landscaping operations, particularly residential and smaller-scale commercial projects. In such projects, the cost of purchasing, maintaining, and operating equipment is of a particular concern and it is often not economically feasible for smaller-scale landscape service providers to own all the necessary equipment. For example, the popular Bobcat brand line or the Kubota line of compact loaders are utilized for a number of landscaping operations, but lack the ability to efficiently contour a surface. Attempts to contour with the standard bucket require tremendous amounts of time, patience, and superb operator skill. To counter this problem, specialized grader equipment is used. However, such grading equipment requires a dedicated pulling mechanism. And therein lies one of the problems, the landscape service-provider must either purchase two separate and expensive pieces of equipment, or the provider must rent a grading device and pulling machine. This wastes time, energy, and money.

Thus, there is a need for a grading device that can quickly adapt and attach to a piece of equipment already utilized by a landscape service provider. In addition, such a grading device should reduce the reliance on operator skill to produce an even and precise grading or contouring of a surface. There is a need for a grading device that minimizes “bounce” on surface irregularities. There is a need for a grading device of reduced complexity to operate, and an improved ease-of-use to connect and disconnect from the tractor. There is need for a grading device with fewer control lines running between the tractor and the grading device. And, there is a need for more ergonomic controls on the tractor to control the grading device. Moreover, such a new grading device should be economical to produce, easy to repair, and be highly maneuverable.

### SUMMARY OF THE INVENTION

One object of the present invention is to overcome the limitations found in the prior-art. Another object of the present invention is to present a grading and contouring device that is economical to produce, highly maneuverable, adaptable to many different motivating mechanisms, easy to repair, and efficient to operate. Yet another objective of the present invention is to use many standardized and readily available, “off-the-shelf” components to enhance reliability and improve serviceability.

In one embodiment, the present invention consists of a surface contouring implement having: a hitching means for removably attaching the implement to a motivating mechanism; a contouring blade assembly connected to the hitching means, the contouring blade assembly comprising a left blade assembly and a right blade assembly connected to a central pivoting means for pivoting the left blade assembly with respect to the right blade assembly; a carriage arm means for extending the effective wheelbase of the implement, the carriage arm means connected to the hitching means and supporting at least a portion of the blade assembly; and a control system means for affecting operation of the implement.

An enhancement of the invention includes a contouring blade assembly having a left blade extension adapted to controllably extend from the left blade assembly and a right blade extension adapted to controllably extend from the right blade assembly.

The surface contouring implement also has a carriage arm means including a left carriage assembly having a first support member and a right carriage assembly having a second support member and wherein at least the first support member or the second support member comprise at least one wheel.

The control system means includes a joystick assembly comprising at least one control lever. And, the joystick assembly further includes a first control lever, a second control lever, and a third control lever. The first control lever is adapted to move in four directions wherein a first direction and a second direction corresponds to controlling a relative height of the left blade assembly relative to the motivating mechanism and a third direction and a fourth direction corresponds to controlling a left blade extension. The second control lever is adapted to move in four additional directions wherein a fifth direction and sixth direction corresponds to controlling a relative height of a right blade assembly relative to the motivating mechanism and a seventh direction and eighth direction corresponds to a controlling a right blade extension. The third control lever is adapted to move in at least two additional directions wherein a ninth and tenth direction control a pivot cylinder.

In an embodiment of the present invention, a surface-contouring implement has a control system means that consists of a joystick assembly adapted to be positioned on the motivating mechanism.

In another embodiment of the present invention, a surface contouring implement for use with a pulling machine includes a frame assembly adapted to attach to the pulling machine at two attaching points provided by the pulling machine; a carriage assembly extending from the frame assembly, the carriage assembly comprising a support member; a first blade having a first-blade first end connected to a pivot assembly; a second blade having a second-blade first end connected to the pivot assembly; and the first blade, the pivot member, and the second blade each being movably attached to the frame assembly.

An enhancement to this embodiment includes a joystick assembly located on the pulling machine and adapted to control corresponding movement on the implement. The joystick assembly further includes at least one control lever adapted to move in at least one direction and send at least one control signal to the implement. Also, the at least one direction movement of the control lever is adapted to affect selective positioning of at least one extension-retraction cylinder on the implement.

In addition, the surface-contouring implement includes at least one wheel connected to the support member. And, the surface contouring implement includes at least one blade extension adapted to selectively extend from an outer edge of either the left blade or the right blade. And, the surface contouring implement includes a hydraulic feed line connecting from the pulling machine and a hydraulic return line connecting to the pulling machine.

The surface contouring implement further includes a pivoting means comprising a mechanism including support structure for the left blade assembly and right blade assembly, and a pivot member aligned along a pivot axis, the mechanism adapted to independently and pivotably rotate the left blade assembly and right blade assembly. And wherein the mechanism includes means for the pivot member to enable positive and negative rotations of substantially about 14-degrees in the vertical plane.

Another embodiment of the present invention includes a method for assembling a surface contouring implement. The method includes: providing a left blade assembly, a right blade assembly, and a pivot member assembly; connecting the left blade assembly and the right blade assembly to the pivot member assembly to maintain selective, independent, and controllable pivot-rotation of the left blade assembly and right blade assembly; providing a carriage arm assembly to support the left blade assembly and the right blade assembly; and connecting the carriage arm assembly to the left blade assembly and the right blade assembly.

Additional steps to the method include: providing a control assembly for independent and remote operation of the left blade assembly, the right blade assembly; and providing means for enabling control signals to be transmitted to the contouring implement.

An enhancement to the method includes: providing a joystick control assembly and adapting the joystick control assembly for mounting on a remote device. Also, the method includes providing at least one blade extension and adapting the extension to selectively extend from either the left blade assembly or the right blade assembly.

### BRIEF DESCRIPTION OF THE DRAWING

FIG. 1 is a right-side view of one embodiment of the present invention, shown in relation to a motivating mechanism.

FIG. 2 is a top view of one embodiment of the present invention.

FIG. 3 is a right-side view of the embodiment of FIG. 2.

FIG. 4 is a right-side view of the embodiment of FIG. 2 and illustrates the invention in raised position.

FIG. 5 is a right-side view of the embodiment of FIG. 2 and illustrates the invention in lowered position.

FIG. 6 is a partial front view of the implement of FIG. 2 in a concave configuration along the line 6-6 of FIG. 2.

FIG. 7 is a right-side view of the implement of FIG. 2 in a convex configuration along the line 7-7 of FIG. 6.

FIG. 8 is a rear view of the embodiment of FIG. 6 showing the blades in a crowned position.

FIG. 9 is a front view of the embodiment of FIG. 6 showing the blades in a v-notch position.

FIG. 10 is a schematic diagram of a possible joystick assembly, electrical lead system, and hydraulic system of one embodiment of the present invention.

FIG. 11 shows a range of movement of the blade extensions according to one embodiment of the present invention.

### DESCRIPTION OF THE INVENTION

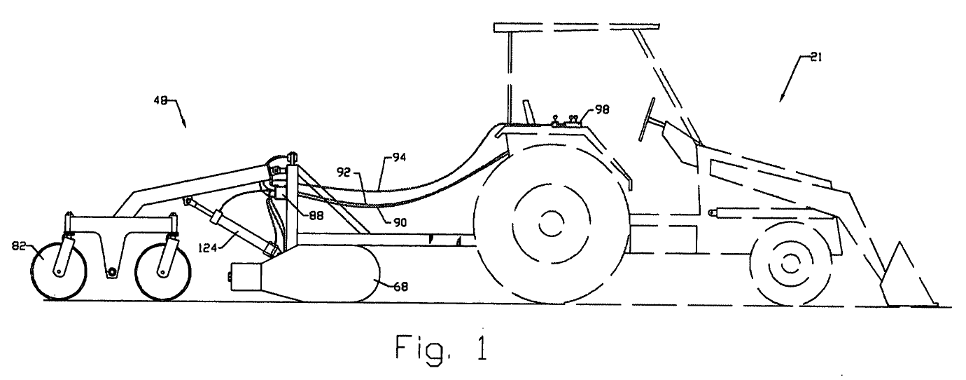

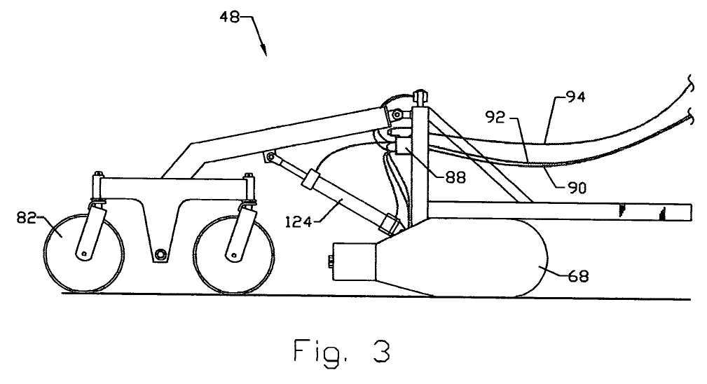

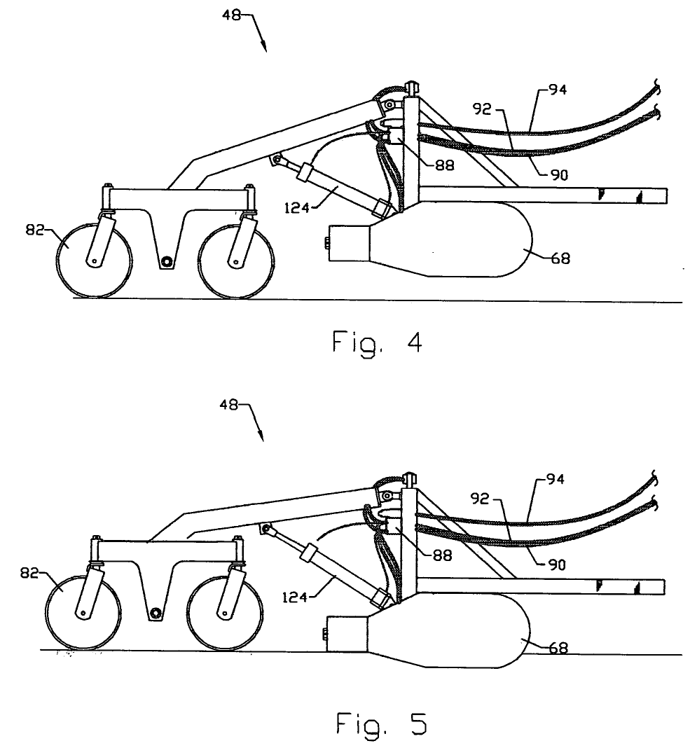

FIGS. 1-11 illustrate contemplated embodiments according to the present invention. FIG. 1 illustrates a motivating mechanism, such as a tractor 21, for example Case model number 570, pulling a contouring grader 48 according to the present invention. The grader 48 is substantially constructed of standard steel tubing and plate available from most steel suppliers, for example. Although many embodiments of this invention are discussed in relation to a particular tractor, it should be understood that any number of tractors or other pulling devices would work equally well. For example, the grader 48 can be configured for a smaller tractor, such as a Kubota brand B-series model tractor having about 18 horsepower to about 30 horsepower, which would be well-suited for landscaping use or residential use, for instance. In other embodiments, the grader 48 can adapt to be pulled by a much larger motivating mechanism: for example, a Case brand 1850K series crawler dozer providing up to 185 horsepower.

The grader 48 adapts to mount to the motivating mechanism. For example, when attached to a mid-sized tractor such as the Case 570, the grader 48 attaches to two points of a standard 3-point hitch mechanism provided by the tractor. Alternatively, when attached to a smaller tractor such as the Kubota B series, the grader 48 attaches to two points directly on the tractor's frame. In a similar manner, the grader 48 can adapt to any suitable motivating mechanism and requires only two, rotatable attaching points and a means for transferring up force from the motivating mechanism.

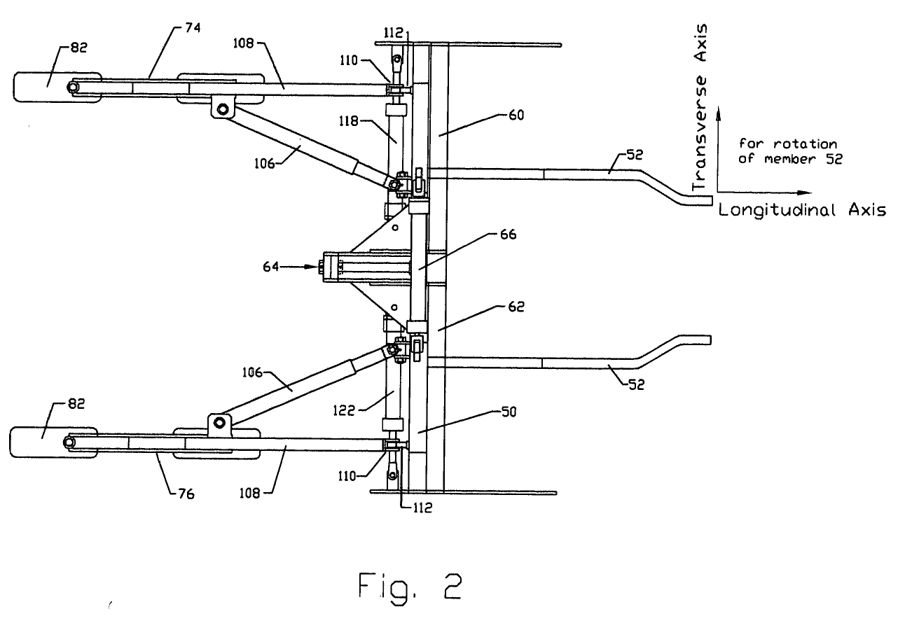

The grader 48 attaching means includes structure to attach to two points and at each point the structure allows rotation about the attaching point. FIG. 2, for example, shows a grader 48 with a central frame assembly 50 connected to a pair of substantially parallel tow-bars 52. Each tow-bar attaches to a corresponding structure provided by the motivating mechanism. In the example of a Case 570 tractor, for example, two of the three standard 3-point hitch locations are utilized. At the attaching point, each tow-bar 52 includes a ball pin. Accordingly, each tow-bar 52 rotates in three axes. Rotation along the vertical axis is controlled by the hydraulic system of the motivating mechanism and is limited by the physical constraints of the specific tractor, for example.

The ball pin permits two-axis rotation so the corresponding tow-bar 52 rotates substantially about +/−10 degrees about the longitudinal axis and transverse axis as indicated in FIG. 2. In addition, the ball pin and related attaching structure, which is well understood in the art, are configured to removably connect to the two attaching points supplied by the tractor 21. The combined three-axis rotation of the tow-bars 52 results in an overall lateral sway of the implement 48 of substantially about +/−3-degrees from longitudinal axis.

In one embodiment, the present invention is a tow-behind grader measuring substantially about 11-feet long (along the axis parallel to the pulling direction of the tractor) and substantially about 7-feet wide (with blade extensions retracted in the narrowest configuration). For example a left blade is substantially about 3.5-feet wide and a right blade is substantially about 3.5-feet wide, resulting in a overall blade width of substantially about 7-feet. However, two blade extensions of substantially about 1.5-feet wide extend the effective overall blade length to about 10-feet. The left and right blades pivot independent of each other; thus, the implement can create about a 5-inch to about 7-inch crown in a single pass, or conversely, an about 5-inch to about 7-inch v-shaped notch. The range of motion of the left and right blades are approximately about 7-degrees upwards and about 7-degrees downwards. Measured from a level blade edge, the overall height of the implement may increase substantially about 8-inches above ground, or be lowered substantially about 4-inches beneath the existing surface. The independent movement of each blade 60 and 62 also allows one blade to rotate substantially about +/−14-degrees for a negative or positive grade when the other blade remains in a substantially horizontal position.

The turning radius, maximum approach angle, and maximum departure angle will vary depending on the specific characteristics of the towing tractor.

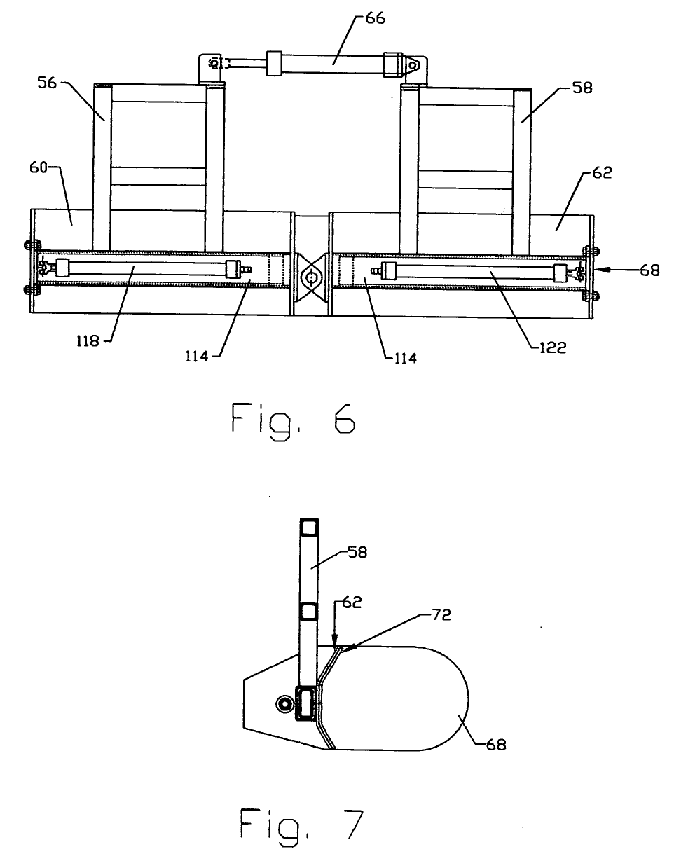

FIG. 1 shows an exemplary embodiment of the present invention. The central frame assembly 50 consists of a left sub-frame 56 and a right sub-frame 58. The left sub-frame 56 supports a left blade 60 (FIG. 6) and, similarly, the right sub-frame 58 supports a right blade 62 (FIG. 6). The right blade 62 shares a common pivot assembly 64 with the left blade 60. The pivot assembly 64 positions intermediate to both the left blade and right blade, at the approximate centerline of the grader 48. FIG. 6 more clearly illustrates these features and some of the surrounding structure is omitted for clarity.

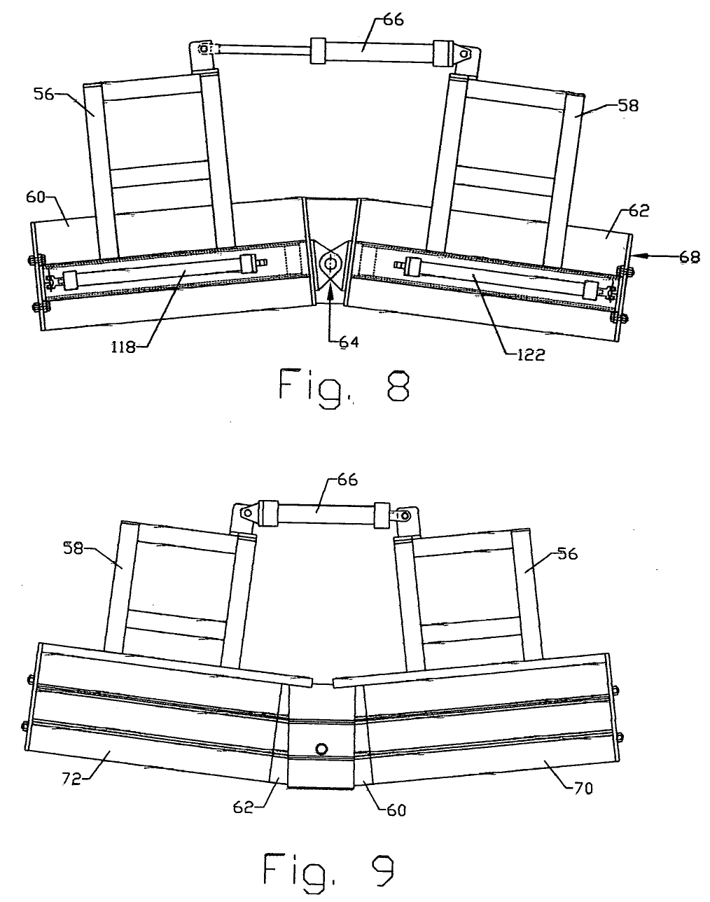

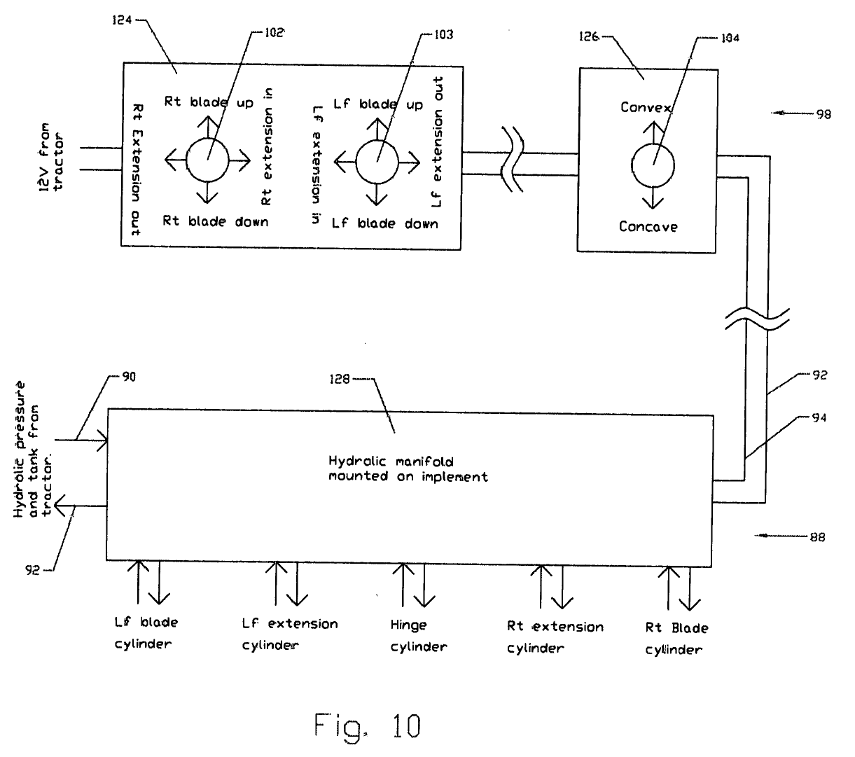

A pivot control cylinder 66 causes selective positioning of the right sub-frame in relation to the left sub-frame with an axis of rotation at the pivot assembly about an axis parallel to the drive direction of the grader 48. Accordingly, the grader 48, for example in the position illustrated by FIG. 8, can concavely shape, or crown, a surface in one pass by extending outward the pivot control cylinder 66. Alternatively, in a second position illustrated by FIG. 9, for example, the grader 48 can create a convex, or v-notch, shape in a surface in one pass by constricting, or moving inward, the pivot control cylinder 66.

As understood in the art, each respective blade 60 and 62 and associated extensions 70 and 72 may include a replaceable blade edge (not shown in the drawings) the blade edge is configured as a straight edge, as scarifying teeth, or other suitably shaped edge as required by the contouring operation. As the blade edge wears out, it can be easily removed and be replaced, for example. In addition, each respective blade 60, 62, 70, and 72 may be painted, polished, or coated with a low-friction material, for example, to enhance the performance and life of the blade for particular grading or contouring operations.

Additionally, FIG. 11 shows a respective blade extension for the left blade 60 and the right blade 62. The left blade extension 70 and right blade extension 72 are each supported by a corresponding lower frame member 114 consisting of tube steel, for example, square and seamless tube steel having an interior coating of a low-friction material. The member 114 is constructed in a way to receive an extension blade support member. The extension blade support member slideably engages the lower frame member 114. The extension blades 70 and 72 operate independently to improve the versatility of the grader 48. Also, each extension blade includes a vertical plate member 68, which serves to contain excess material removed from the contouring process and eliminates spill-over. Each respective vertical plate member also facilitates observation of the edge of the trailing blade, whether extended to the widest range of movement, restricted to the narrowest configuration, or at any intermediate position. Each respective plate 68, moreover, facilitates tracking the various blades and extensions in the grading or contouring surface.

One problem prevalent in many prior-art devices is bounce, or the unwanted lifting of the trailing-device from the surface being graded or contoured. Bounce is caused by inevitable surface irregularities. Prior-art devices typically operate with the tractor hydraulics in a “locked” position and ride directly on the ground. As a result, the prior-art devices bounce rather easily when pulled across a field. The tendency of a grading implement to bounce decreases substantially in proportion to the length of the longitudinal axis of the implement. Accordingly, the present invention incorporates a carriage arm and carriage assembly, which essentially extends the longitudinal axis of the grader 48. The carriage arm consists of a left carriage arm 74 and a right carriage arm 76. Each respective carriage arm extends from the frame assembly 50 to lengthen the longitudinal axis of the grader 48. To maintain independent operation of the left and right blades 60 and 62, respectively, the carriage arms 74 and 76 connect or attach to the corresponding left or right sub frame 56 or 58 using ball connection pins 110 to allow 3-axis rotation of substantially about +/−10-degrees on each axis.

The left carriage assembly 78 supports a left carriage arm 74. Mounted to the left carriage arm is at least one support member 82, for example, two wheels. Similarly, the right carriage assembly 80 is attached to the right carriage support arm 108 and supports or carries a right carriage arm 76 with corresponding support members 82, or wheels. Any number of wheels or support members could be attached to the carriage assembly. In one possible embodiment, each wheel is pivotably mounted to the chassis, enhancing maneuverability. Additionally, each wheel can rotate 360-degrees around the vertical axis. Movement within the vertical axis is enabled by the arrangement of the respective left and right carriage arm 74 and 76. Each carriage arm consists of a corresponding carriage support arm 108 that extends from the frame 50 at an attaching point. The attaching point 112 includes a ball pin assembly 110, which enables 3-axis rotation. For example, the 3-axis rotation in one embodiment is substantially at least about +/−10-degrees in each direction. Opposite the attaching-point end of the carriage support arm 108 is the corresponding left or right carriage assembly 76 or 78. To stabilize the carriage assembly, a corresponding left and right strut 106 connects to the frame 50 and links the respective chassis 76 and 78.

For enhanced stability of the grader 48, each carriage arm 76 and 78 can rotate away from the center of the grader. To enable this rotation, the corresponding left or right strut 106 extends outwardly or inwardly. The strut consists of nested tube steel. The outer strut is adapted to slidably receive the inner strut member. To prevent un-intended extension of the strut, a locking pin or bolt is removably secured, as is well-understood in the art. Alternatively, the strut 106 could be replaced by a hydraulic cylinder. Control of the cylinder could be enabled by the joystick assembly 98, for example, allowing remote manipulation and independent operation of the left and right stabilizing mechanisms.

The hydraulic control module 88 mounts to the grader 48 at a suitable point on the frame 50, for example. The control module 88 includes a feed line 90 from the tractor. The feed line 90 includes a quick-connect/disconnect attaching mechanism as is well-understood in the art for easily attaching the line and removing the line from the tractor and/or from the hydraulic control module 88. Similarly, a hydraulic return line 92 completes the hydraulic fluid loop with the tractor-provided hydraulic reservoir. An electrically-activated hydraulic choke (not shown in the drawings) enables remote control of the hydraulic fluid flow on the grader 48. The hydraulic control module 88 includes a number of interfacing ports for directing hydraulic fluid to and from each of the associated control cylinders and all necessary hydraulic supply and return lines. The control cylinders include a left blade cylinder 116, a left blade extension cylinder 118, a hinge cylinder 66, a right extension cylinder 122, and a right blade cylinder 124. One possible control cylinder is an extension-retraction mechanism, such as an “8DB” model cylinder available from Cross Manufacturing Incorporated of Lewis, Kans., USA and are widely available through many farm equipment and parts suppliers. Associated with the control module 88 are all necessary electronics to manipulate a corresponding solenoid that control the fluid flow to each associated and corresponding cylinder (the solenoids, being well-understood in the art, are omitted from the drawings). An optional left strut cylinder and optional right strut cylinder may be included as well (not shown in the drawings).

Although the hydraulic system illustrated in the figures depicts a tractor-provided hydraulic reservoir and pump, such components, alternatively, could position on the grader device 48. In this alternative embodiment, an electric lead line from the tractor powers an electric pump located on the grader. The grader-pump draws hydraulic fluid from a grader-mounted fluid reservoir. The remote mounted joystick assembly 98 operates similarly to other exemplary embodiments. In yet another embodiment, the hydraulic cylinders could be replaced with other fluid cylinders, such as compressed air cylinders. Or, each cylinder could be replaced by a manually adjustable strut and locking mechanism. Generally, however, cylinder—as used in this document—refers to a device that enables selective positioning of a structure or a tool on the implement. A tool is, for example, a blade, a blade extension, or a support wheel. The cylinder enables selective movement within a predetermined range of movement and includes any necessary support structure and control mechanisms to affect this movement.

The tractor is modified to include the joystick assembly 98, which is placed in a convenient and easy-to-reach location, for example. The joystick assembly 98, in one possible embodiment, consists of three separate boxes, each control box having a single control lever. This configuration permits the most flexibility for mounting the joystick control assembly 98 on the motivating mechanism. In another embodiment, the joystick control assembly 98 consists of a single box with 3 control levers.

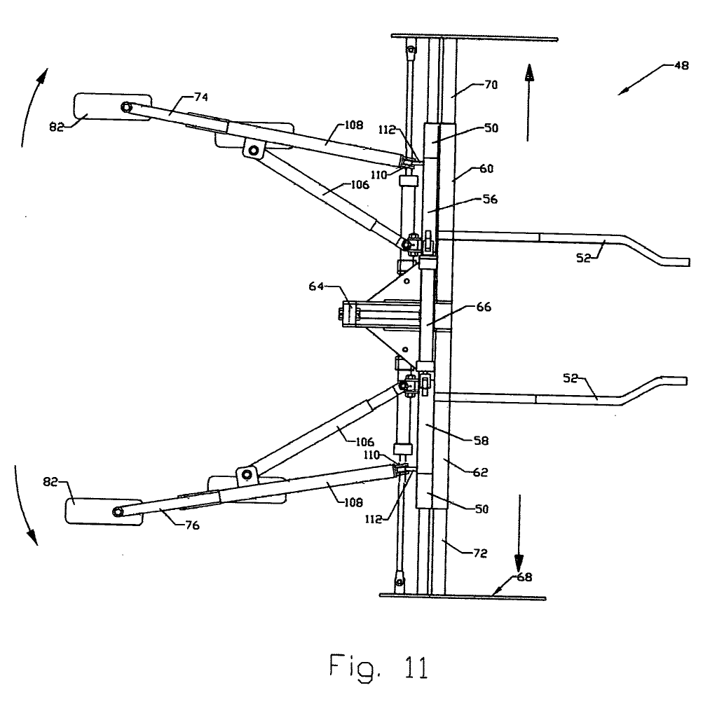

In another embodiment, for example, as illustrated in FIG. 10, the joystick assembly 98 consists of two control boxes 124 and 126. Box 124 has 2 control levers 102 and 103. Box 126 has 1 control lever 104. In this representative embodiment, control lever 102, for example, is adapted to manipulate the right blade 62 and right blade extension 72. for example, moving the lever 102 forwards raises the right blade, moving the lever backwards lowers the blade, moving right retracts the right blade extension and moving left extends the extension blade. Similarly, control lever 103 controls the left blade 60 and left blade extension 70. And, lever 104 control the hinge cylinder to rotate the blades in either a convex or concave configuration. In this example, the lever 104 has two additional directions of movement that are not currently used. However, one could easily incorporate another cylinder for any number of purposes and use this lever 104 to manipulate it. Also, additional levers could be added to the assembly 98 as additional cylinders are incorporated with the grader 48, for example.

Although specific control levers are associated with specific functions and, moreover, specific directions enable particular movement on the grader, it should be understood that this exemplary description is not limiting, nor crucial to the scope, spirit, and intention of the invention.

In one embodiment, one electrical control line extends from the joystick assembly 98 to the grader 48. The control line consists of eleven “hot” leads, ten of which correspond to each specific hydraulic cylinder on the grader and one to control the hydraulic choke on the grader. The remaining lead is a ground wire. The control line links each box of the assembly 98 and is used to transfer electrical signals to a hydraulic control module 88 on the grader 48. FIG. 11 shows a possible hydraulic control module 88, which consists of a hydraulic manifold 128 and solenoids (not illustrated) corresponding to each hydraulic cylinder on the grader. In addition, the control line includes quick-connect/disconnect connecting means at one or both ends to enable easy removal of the lines from the grader or from the joystick control 98, which facilitates easy and quick attachment and disengagement of the grader 48 from the tractor. Although it is desirable to have only one control line extending between the grader and the tractor, multiple control lines, for example lines 94 and 96, will also work.

To simplify construction of the grader 48, off-the-shelf electrical connectors and cables can be used. Such connectors come in six-pin configurations for example. Thus, two connectors and two cables can be used for the 12 leads. Also, additional hydraulic cylinders may be used on the grader. This could require additional leads from the tractor-mounted assembly 98. Accordingly the objective of quick removal of the control line and the objective of using standard parts to reduce cost and improve reparability of the device may be occasionally at odds. However, these perhaps conflicting objectives should not detract from the spirit and essence of this invention.

To attach to or remove the grader 48 from a motivating mechanism, an operator raises or lowers the left and right carriage assemblies to present the tow-bars at the height of the two attaching points provided by the motivating mechanism. Then, the tow-bars engage the attaching points using well-understood ball pins. The grader 48 is secured and optional tow-chains attach between the grader and the motivating mechanism. Simple quick connects are connected to the hydraulic supply valve and the hydraulic return valve presented by the motivating mechanism. Finally, the electrical control line is run from the previously mounted joystick assembly located on the motivating mechanism to the hydraulic control module on the grader.

To operate the grader 48, an operator attaches the device to a tractor and places the tractor supplied hydraulic control in “float” mode. Now, the operator simply moves the joystick control levers 102,103, and 104 to position the left and right blades, their respective extension, the pivot assembly, and the overall height to a desired configuration. The combination of the device's 48 weight, extended wheelbase of the carriage assembly 78 and 80, and setting the motivating mechanism's hydraulic system to the “float” position substantially eliminates operator skill to obtain a desired contour regardless of the inevitable surface irregularities.

In one embodiment of the invention, the grader 48 utilizes hitching means for selectively and removably attaching the grader 48 to a pulling machine, motivating mechanism, tractor, dozer, and the like. The hitching means comprises cooperating structure provided by the tractor, for example, and the grader 48 and includes two attaching points. The two attaching points enable rotatable connection and sufficient structure to transfer the mechanical energy, or down-force, between the tractor 21 and the grader 48. The hitching means further includes sufficient structure for pulling the weight of the grader 48 and any anticipated load caused by surface material drag on the various blades and extensions, for example.

In one possible embodiment of the present invention, the grader 48 incorporates a control system means. The control system means includes an assembly located on the tractor 21, for example. This remotely located assembly, for example, joystick control assembly 98 includes a means for transferring control signals to the grader 48, specifically at the hydraulic control module 88. The means for transferring control signals includes at least one lead line, such as transfer line 94. However, other control-signal sending means are contemplated, for example, radio-frequency control signals, or infra-red pulses. Accordingly, the grader 48 is adapted to send and receive corresponding radio-frequency signals or infra-red pulses.

The terms and expressions employed in the foregoing portions of this specification are terms of description and should not be used to limit the invention or exclude equivalents of the features shown and described or portions of those features. The scope of the invention is defined and limited only by the claims that follow.

I claim:

1. A surface contouring implement comprising:
a hitching means for removably attaching the implement to a motivating mechanism;
a contouring blade assembly connected to the hitching means, the contouring blade assembly comprising a left blade assembly and a right blade assembly connected to a central pivoting means for pivoting the left blade assembly with respect to the right blade assembly;
a carriage arm means for extending the effective wheelbase of the implement, the carriage arm means connected to the hitching means and supporting at least a portion of the blade assembly; and
a control system means for affecting operation of the implement.

2. The surface contouring implement of claim 1 wherein the contouring blade assembly comprises a left blade extension adapted to controllably extend from the left blade assembly and a right blade extension adapted to controllably extend from the right blade assembly.

3. The surface contouring implement of claim 1 wherein the carriage arm means comprises a left carriage assembly having a first support member and a right carriage assembly having a second support member and wherein the first support member or the second support member comprise at least one wheel.

4. The surface contouring implement of claim 1 wherein the control system means comprises a joystick assembly comprising at least one control lever.

5. The joystick assembly of claim 4 comprising a first control lever, a second control lever, and a third control lever;
the first control lever is adapted to move in four directions wherein a first direction and a second direction corresponds to controlling a relative height of the left blade assembly relative to the motivating mechanism,
a third direction and a fourth direction corresponds to controlling a left blade extension;
and wherein the second control lever is adapted to move in four additional directions wherein
a fifth direction and sixth direction corresponds to controlling a relative height of a right blade assembly relative to the motivating mechanism,
a seventh direction and eighth direction corresponds to a controlling a right blade extension; and
wherein the third control lever is adapted to move in at least two additional directions wherein
a ninth and tenth direction control a pivot cylinder.

6. The surface contouring implement of claim 1 wherein the control system means comprises a joystick assembly adapted to be positioned on the motivating mechanism.

7. The surface contouring implement of claim 1 wherein the pivoting means comprises a mechanism including support structure for the left blade assembly and right blade assembly, and a pivot member aligned along a pivot axis, the mechanism adapted to independently and pivotably rotate the left blade assembly and right blade assembly.

8. A surface contouring implement for use with a pulling machine, the implement comprising:
a frame assembly adapted to attach to the pulling machine at two attaching points provided by the pulling machine;
a carriage assembly extending from the frame assembly, the carriage assembly comprising a support member;
a first blade having a first-blade first end connected to a pivot assembly;
a second blade having a second-blade first end connected to the pivot assembly; and
wherein the first blade, the pivot member, and the second blade each being movably attached to the frame assembly.

9. The surface contouring implement of claim 8 further comprising a joystick assembly located on the pulling machine and adapted to control corresponding movement on the implement.

10. The joystick assembly of claim 9 further comprising at least one control lever adapted to move in at least one direction and the at least one control lever adapted to send at least one control signal to the implement; and the at least one direction adapted to affect selective positioning of at least one extension-retraction cylinder on the implement.

11. The surface contouring implement of claim 8 further comprising at least one wheel connected to the support member.

12. The surface contouring implement of claim 8 further comprising at least one blade extension adapted to selectively extend from an outer edge of either the left blade or the right blade.

13. The surface contouring implement of claim 8 further comprising a hydraulic feed line connecting from the pulling machine and a hydraulic return line connecting to the pulling machine.

14. The surface contouring implement of claim 8 wherein the pivoting means comprises a mechanism including support structure for the left blade assembly and right blade assembly, and a pivot member aligned along a pivot axis, the mechanism adapted to independently and pivotably rotate the left blade assembly and right blade assembly.

15. The mechanism of claim 14 wherein the pivot member enables positive and negative rotations of substantially about 14-degrees in the vertical plane.

16. A method for assembling a surface contouring implement comprising:
providing a left blade assembly, a right blade assembly, and a pivot member assembly;
connecting the left blade assembly and the right blade assembly to the pivot member assembly to maintain selective, independent, and controllable pivot-rotation of the left blade assembly and right blade assembly;
providing a carriage arm assembly to support the left blade assembly and the right blade assembly; and
connecting the carriage arm assembly to the left blade assembly and the right blade assembly.

17. The method of claim 16 further comprising providing a control assembly for independent and remote operation of the left blade assembly, the right blade assembly; and
providing means for enabling control signals to be transmitted to the contouring implement.

18. The method of claim 16 further comprising providing means for the pivot member assembly to rotate each respective left blade assembly and right blade assembly independently and assembling said means to the surface contouring implement.

19. The method of claim 16 further comprising providing a joystick control assembly and adapting the joystick control assembly for mounting on a remote device.

20. The method of claim 16 further comprising providing at least one blade extension and adapting the extension to selectively extend from either the left blade assembly or the right blade assembly.
